(19) United States
(12) Patent Application Publication
(10) Pub. No.: US 2007/0250827 A1
(43) Pub. Date: Oct. 25, 2007

(54) APPARATUS FOR SUPPORTING PROGRAM DEVELOPMENT, AND OPERATION METHOD FOR THE APPARATUS

(75) Inventors: Ryuichiro Ohyama, Kanagawa-ken (JP); Seiji Hayashida, Kanagawa-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/738,014

(22) Filed: Apr. 20, 2007

(30) Foreign Application Priority Data
Apr. 20, 2006 (JP) 2006-117083

(51) Int. Cl. G06F 9/44

(52) U.S. Cl. 717/162

(57) ABSTRACT

A program development supporting apparatus for generating, displaying, and editing section locating of a function and memory locating of a section manually or automatically includes: a function calling information input unit configured to extract call relation of a function from a source file; a link configuration file input unit configured to extract locating information on an absolute section from a configuration file used when linking; a section editing unit configured to place the function in one of a relocatable section and the absolute section; a function locating configuration file output unit configured to output the locating information on the function as a function locating configuration file; and a link configuration file output unit configured to output the locating information on the relocatable section and the absolute section.

### CROSS REFERENCE TO RELATED APPLICATIONS

This application is based upon and claims the benefit of priority under 35 USC §119 from the prior Japanese Patent Application No. 2006-117083, filed on Apr. 20, 2006, the entire contents of which are incorporated herein by reference.

### BACKGROUND OF THE INVENTION

1. Field of the Invention

The present invention pertains to an apparatus for supporting program development and a method for an operation of the apparatus for supporting program development. Especially, the present invention pertains to the apparatus which is used to develop an application for an embedded processor and generates, displays, and edits a section location of a function and a memory location of the section manually or automatically, and to the method for operation of the apparatus.

2. Description of the Related Art

It is general that the capacity of an instruction memory for program execution is less than the program size in an embedded processor. Moreover, it is in no small way when a mechanism that the instruction memory of limited capacity like a virtual memory achieved by using an instruction cache and an MMU, etc. is leveraged is not composed since the composed mechanism is comparatively limited. In one of the techniques used for this case, there is a program overlay.

The overlay is to rewrite a part of a program code and data located in the instruction memory and a data memory by other codes and data according to the program execution. When executing a program, several function executed in the now and the near future is located on the instruction memory instead of locating the entire program on the instruction memory. During execution, code of functions which are unnecessary for the execution of that time is overwritten by code of new functions. For example, in the case of a program that function B and function C are called in order from function A, a method that only function A and function B are located on the instruction memory when beginning execution, a code of function C is overwritten in an area where function B is located when function B execution ends, and then function C is called is considered.

When the overlay is executed, the entire program is located to a memory (ROM and SDRAM of an external connection etc.) low-speed by large capacity other than the instruction memory of the processor, and will transmit only a part necessary for executing to the instruction memory as the need arises. In many cases, it is possible to reduce the capacity of the instruction memory installed in the processor by using the overlay since the instruction memory of the processor is expensive while the instruction memory is highspeed compared with ROM and SDRAM. As a result, the miniaturization and the reduction in costs of the embedded processor and a system LSI embedding the embedded processor can be achieved.

When the instruction code is overlaid, there is a problem that it is difficult to determine which part in the entire code to which area of the instruction memory according to which timing to be transmitted. Although it is necessary to locate a code that should be executed on the instruction memory at necessary point, it is necessary to design so that another code that existed at the same time in the locating area till then is not referred. When the program execution arrives at certain area, and if the code on that area is overwritten with another code by mistake, the program will be executed with code that the program designer is not intended. As a result, there is risk that the entire program can not execute normally.

Moreover, such problem may occur not only in the design of the program but also in further modification of that program. For example, the case where function B is continuously located to the address in function A back is considered. When function A is amended later and code size of function A grows, it is necessary to move the locating area of function B back to the extent that the size of function A increases or to move to another area of no relation to function A. Otherwise, a head area of function B is overwritten in the code in the end part of function A, and the code not intended is executed when function B is called. Since the adjustment of the locating area of amending like this may influence other codes except function A and function B, the reexamination of the code locating of the entire program might become necessary for some amending the program. As a result, far more time might be spent on the design of the code locating compared with the design of the program body. Moreover, since the code that the designer does not intend is executed when the locating is incorrect, the discovery and amending the trouble point are difficult.

Furthermore, in general, while the locating of the code on the memory is performed with the section including one or more functions as a unit, what kind of section may be made, which function be located in the section, and to which area of the entire instruction memory the section is located also become a big problem in the design. Usually, since the transmitting frequency switching the section at the time of execution from an external memory to the instruction memory decreases when designing so that a lot of functions may be included in the section, it contributes to shortening the execution time. On the other hand, since the size of the section grows, locating in the limited size instruction memory becomes difficult. Therefore, the overwriting of wrong code above-mentioned becomes easy to occur.

Conventionally, a program designer or a program development person has designed the code locating in overlay as a part of the program development manually. However, the design cost according to the overlay of the program has grown as the program scale becomes large or more so that it is not possible to disregard it compared with the design cost of the entire program. As a result, the case to have a big influence on the program development for an embedded processor has occurred.

A memory aliasing apparatus that has flexibility by the storage of the common module with high operation frequency in the preliminary addressing possible circuit bank, and improving the efficiency of the memory aliasing has already been disclosed in Japanese patent Laid Open Publication (Kokai) No. 2001-22639.

Moreover, an apparatus and a method for language processing of aiming at the improvement of the capacity by automatically selecting an optimal combination of the function that should locate to a specific space and reducing the user's imposition when an object module file is generated have already been disclosed in Japanese patent Laid Open Publication (Kokai) No. H09-034725.

### SUMMARY OF THE INVENTION

According to an embodiment of the present invention, an apparatus for supporting program development including: (a) a function calling information input unit configured to extract call relation of a function from a source file; (b) a link configuration file input unit configured to extract locating information on an absolute section from a configuration file used when linking; (c) a section editing unit configured to place the function in one of a relocatable section and the absolute section; (d) a function locating configuration file output unit configured to output the locating information on the function as a function locating configuration file; and (e) a link configuration file output unit configured to output the locating information on the relocatable section and the absolute section can be provided.

According to another embodiment of the present invention, an apparatus for supporting program development including: (a) a function calling information input unit configured to extract call relation of a function from a source file; (b) a link configuration file input unit configured to extract locating information on an absolute section from a configuration file used when linking; (c) a section allocation unit configured to obtain allocation of program code to an instruction memory area; (d) a function locating configuration file output unit configured to output the locating information on the function as a function locating configuration file; and (e) a link configuration file output unit configured to output the locating information on the relocatable section and the absolute section can be provided.

According to another embodiment of the present invention, a method for an operation of the apparatus for supporting program development including: (a) extracting call relation of a function from a source file; (b) extracting locating information to a relocatable section of the function from a function locating information file; (c) extracting locating information on an absolute section from a configuration file used when linking; (d) placing the function in one of a relocatable section and the absolute section; (e) outputting the locating information on the function as a function locating configuration file; and (f) outputting the locating information on the relocatable section and the absolute section can be provided.

### BRIEF DESCRIPTION OF THE DRAWINGS

FIG. 1 is an illustration showing an example of a process flow and a file I/O flow when application is created by a program development supporting apparatus according to a first embodiment of the present invention.

FIG. 2 is a functional block diagram showing an example of processing procedure of the program development supporting apparatus according to the first embodiment of the present invention.

FIG. 3 is a simplified block diagram showing an example of the program development supporting apparatus according to the first embodiment of the present invention.

FIG. 4 is an illustration showing an example of a display screen of the program development supporting apparatus according to the first embodiment of the present invention.

FIG. 5 is an illustration showing an example of a process flow and a file I/O flow when application is created by a program development supporting apparatus according to a second embodiment of the present invention.

FIG. 6 is a simplified block diagram showing an example of the program development supporting apparatus according to the second embodiment of the present invention.

FIG. 7 is a flowchart diagram for explaining an example of entire processing procedure in the program development supporting apparatus according to the second embodiment of the present invention.

FIG. 8 is a flowchart diagram for explaining an example of processing procedure of the consolidation between preceding sibling and following sibling in the program development supporting apparatus according to the second embodiment of the present invention.

FIG. 9 is a flowchart diagram for explaining an example of processing procedure of consolidation between parent and child in the program development supporting apparatus according to the second embodiment of the present invention.

FIG. 10 is schematic drawing showing an example of a call graph of a program P1 in the program development supporting apparatus according to the second embodiment of the present invention.

FIG. 11 is schematic drawing for explaining an example of a result of the function section allocation of program P in the program development supporting apparatus according to the second embodiment of the present invention.

FIG. 12 is schematic drawing showing an example of a function locating configuration file corresponding to a result of the function section automatic allocation of program P in the program development supporting apparatus according to the second embodiment of the present invention.

FIG. 13 is schematic drawing showing an example of a link configuration file corresponding to the function section automatic allocation of a program P in the program development supporting apparatus according to the second embodiment of the present invention.

FIG. 14 is a flowchart diagram for explaining an example of entire processing procedure in a program development supporting apparatus according to a third embodiment of the present invention.

FIG. 15 is a flowchart diagram for explaining an example of processing procedure of a section consolidation based on function call frequency in the program development supporting apparatus according to the third embodiment of the present invention.

FIG. 16 is schematic drawing showing an example of a program P2 in the program development supporting apparatus according to the third embodiment of the present invention.

FIG. 17 is schematic drawing showing an example of a call graph of the program P2 in the program development supporting apparatus according to the third embodiment of the present invention.

FIG. 18 is schematic drawing showing an example of an execution transition frequency between functions of the program P2 in the program development supporting apparatus according to the third embodiment of the present invention.

FIG. 19 is schematic drawing for explaining an example of a result of the function section allocation of the program P2 in the program development supporting apparatus according to the third embodiment of the present invention.

### DETAILED DESCRIPTION OF THE INVENTION

Various embodiments of the present invention will be described herein below with reference to the accompanying drawings. It is to be noted that the same or similar reference numerals are applied to the same or similar parts and elements throughout the drawings, and the description of the same or similar parts and elements will be omitted or simplified. However, since the drawing is schematic, a plane size etc. of each block should note the difference from the size etc. of the reality. Moreover, of course the inclusion of the part where the relation and the ratio of sizes each other are different between the drawings.

Moreover, the following embodiments illustrate the apparatus and the method for the embodiment of the technical thought of this invention, and the technical thought of this invention doesn't specify the locating etc. of the component of each block for the one listed below. The technical thought of this invention can add various changes within the range of the claim.

In the embodiments of the present invention, when an application for an embedded processor is developed, a program development supporting apparatus which generates/displays/edits a section location of a function and a memory location of the section manually or automatically, and a method for operation of the program development supporting apparatus are disclosed.

According to the program development supporting apparatus and the method for the operation of the program development supporting apparatus of the embodiments of the present invention, when the application for an embedded processor is developed, the section locating of the function and the memory locating of the section can be generated/displayed/edited manually or automatically.

### First Embodiment

Hereafter, the mechanism that determines the code locating in overlay manually will be described in the first embodiment of the present invention.

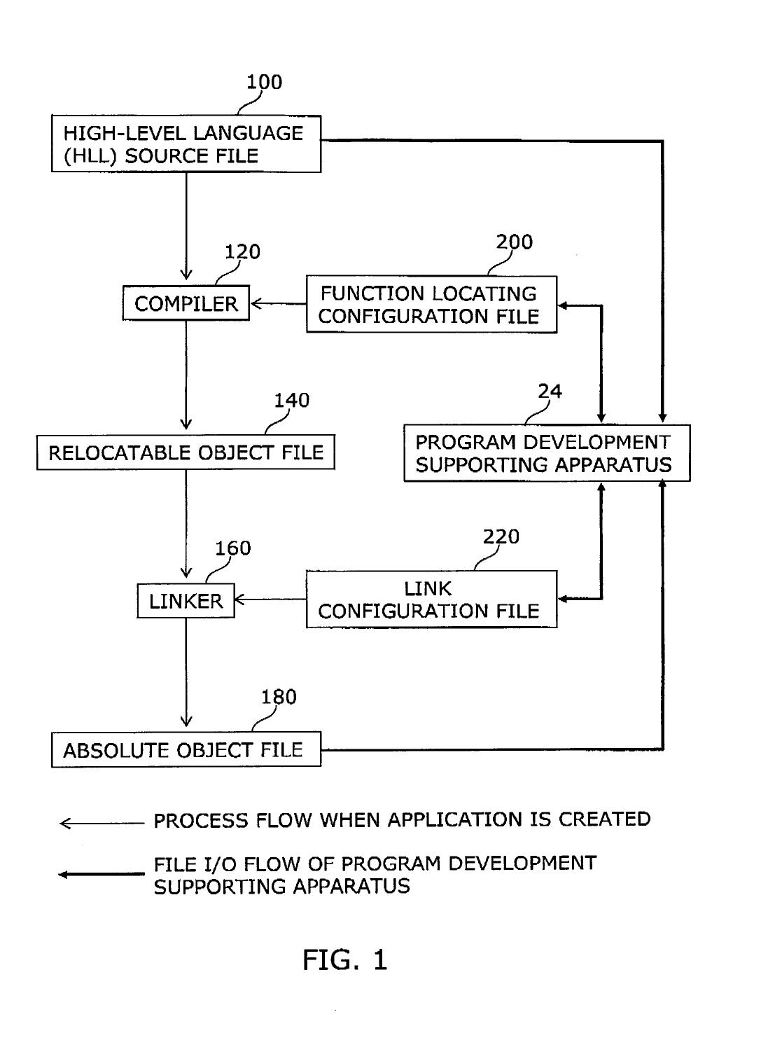

As shown in FIG. 1, a program development supporting apparatus (Program Section Assignment Generator (PSAG)) 24 according to the first embodiment of the present invention cooperates with a High-Level Language (HLL) source file 100, a compiler 120, a relocatable object file 140, a linker 160, a absolute object file 180, a function locating configuration file 200, and a link configuration file 220.

In FIG. 1, solid line arrows show a process flow when application is created. Moreover, in FIG. 1, the part of thin arrows shows an I/O flow of each file of the program development supporting apparatus.

FIG. 1 shows the relation of the file that the program development supporting apparatus according to the first embodiment of the present invention inputs/outputs and other tools that create an application program.

The program development supporting apparatus 24 according to the first embodiment of the present invention displays call graph of target application program, which contains sets of all function call paths. The call graph is used to design overlay of the application program. Furthermore, the locating to the relocatable section of each function and the locating when the relocatable section is located to an actual memory are displayed and edited. And then, the file to reflect an editing result to an actual compiling result is output. An expected function locating and an expected section locating can be achieved by creating the application program again by using the output file.

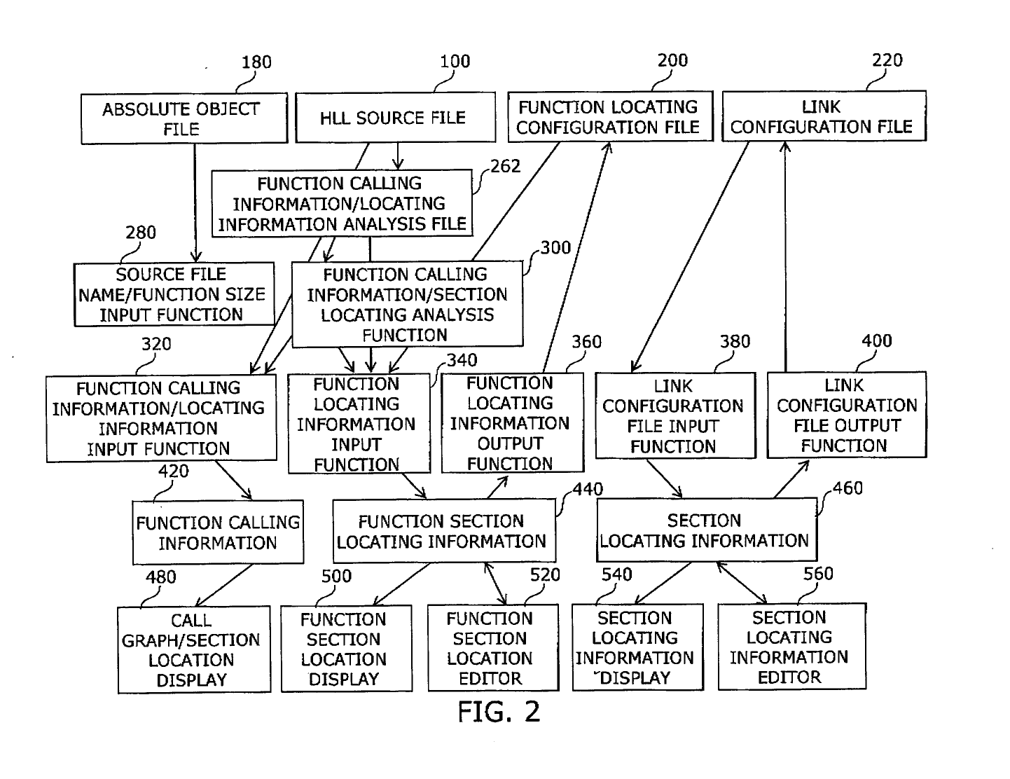

A functional block of the program development supporting apparatus 24 according to the first embodiment of the present invention is shown schematically as shown in FIG. 2. The program development supporting apparatus 24 according to the first embodiment of the present invention includes each function unit having an absolute object file 180, a High-Level Language (HLL) source file 100, a function locating configuration file 200, a link configuration file 220, and a function calling information/locating information analysis file 262.

The program development supporting apparatus 24 according to the first embodiment of the present invention further includes each function unit having a source file name/function size input function 280, a function calling information/section locating analysis function 300, a function calling information/locating information input function 320, a function locating information input function 340, a function locating information output function 360, a link configuration file input function 380, a link configuration file output function 400, a function calling information 420, a function section locating information 440, a section locating information 460, a call graph/section location display 480, a function section location display 500, a function section location editor 520, a section locating information display 540, and a section locating information editor 560. The arrow in FIG. 2 shows the processing flow of the data between each function units.

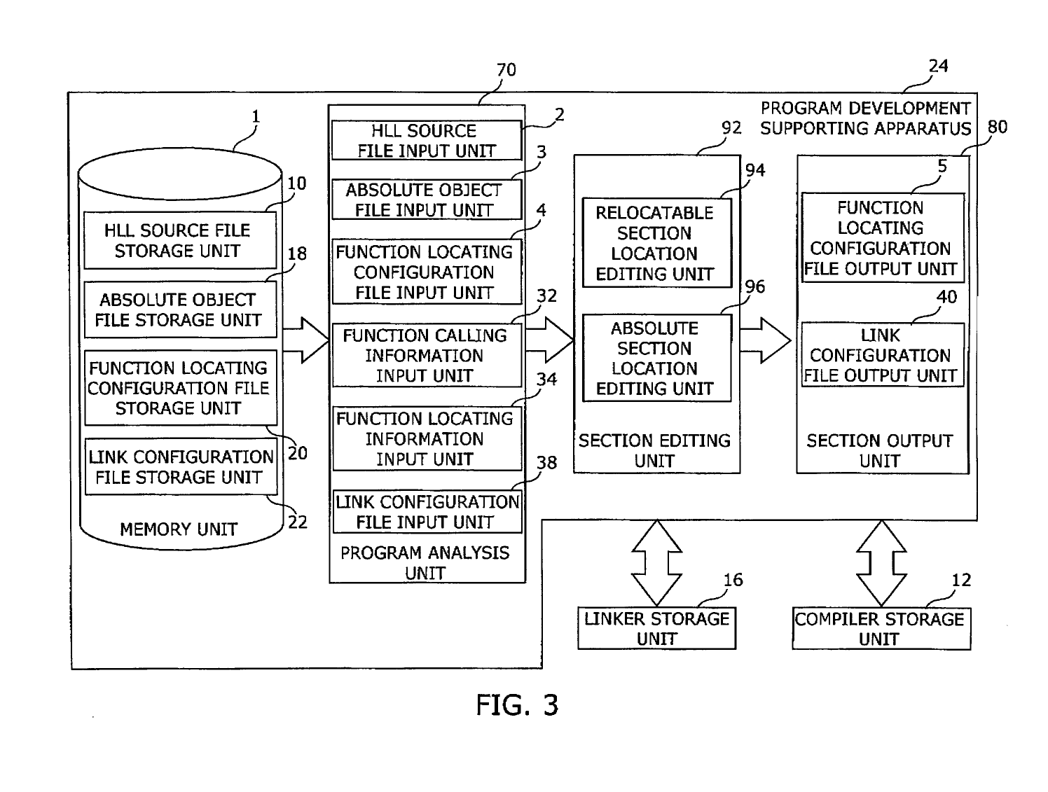

As shown in FIG. 3, the program development supporting apparatus 24 according to the first embodiment of the present invention includes a memory unit 1, a program analysis unit 70, a section editing unit 92, and a section output unit 80. A linker storage unit 16 and a compiler storage unit 12 are located outside.

The memory unit 1 includes a High-Level Language (HLL) source file storage unit 10 configured to store one or more High-Level Language (HLL) source files, an absolute object file storage unit 18 configured to store an absolute object file, a function locating configuration file storage unit 20 configured to store a function locating configuration file, and a link configuration file storage unit 22 configured to store a link configuration file.

The program analysis unit 70 includes a High-Level Language (HLL) source file input unit 2, an absolute object file input unit 3, a function locating configuration file input unit 4, a function calling information input unit 32, a function locating information input unit 34, and a link configuration file input unit 38. The HLL source file input unit 2 inputs the High-Level Language (HLL) source file stored in the HLL source file storage unit 10. The absolute object file input unit 3 inputs the absolute object file stored in the absolute object file storage unit 18. The function locating configuration file input unit 4 inputs the function locating configuration file stored in the function locating configuration file storage unit 20. The function calling information input unit 32 inputs call relation of the function from the source file. The function locating information input unit 34 inputs locating information from a function locating information file to a relocatable section of the function. The link configuration file input unit 38 inputs locating information on the absolute section from configuration file used when linking.

The section editing unit 92 includes a relocatable section location editing unit 94 and an absolute section location editing unit 96. The relocatable section location editing unit 94 receives data from the program analysis unit 70, and locates the function to the relocatable section and edits it. The absolute section location editing unit 96 locates the function to the absolute section and edits it.

The section output unit 80 includes a function locating configuration file output unit 5 and a link configuration file output unit 40. The function locating configuration file output unit 5 receives data from section editing unit 92, and outputs the function locating configuration file. The link configuration file output unit 40 outputs locating information on the relocatable section and the absolute section.

The method for the operation of the program development supporting apparatus according to the first embodiment of the present invention includes: a function calling information input step extracting the call relation of the function from source file; a function locating information input function step extracting the locating information from the function locating information file to the relocatable section of the function; a link configuration file input function step extracting the locating information on the absolute section from the configuration file used when linking; a section edit step providing the function in the relocatable section or the absolute section; a function locating configuration file outputting step outputting the locating information on the function as the function locating configuration file; and a Link configuration file output function step outputting the locating information on the relocatable section and the absolute section.

More in detail, the program development supporting apparatus according to the first embodiment of the present invention includes: a function calling information/locating information analysis file input function configured to extract the call relation of the function from the source file of high-level language, to input a result of analyzing call relation of the function with another tool, and to input a file that instructs the call relation manually; a function locating information input function configured to extract the locating information of functions in relocatable sections from the source files or the function locating information file, which contains information to locate function for compiler; a link configuration file input function analysis function configured to extract the locating information of the relocatable section and the locating information on the absolute section that couples the relocatable section generated from the configuration file used when linking; a display function configured to display the call relation of the function, the function located to relocatable section, and information on the relocatable section and the absolute section; an editing function configured to edit to which relocatable section to locate the function, to which absolute section to locate the relocatable section, and to which address to locate the absolute section; and a link configuration file output function configured to output the locating information on the relocatable section and the locating information on the absolute section as the configuration file used when linking.

The program development supporting apparatus according to the first embodiment of the present invention may further include an absolute object file input analysis function configured to extract information of the source file, section information, and the function size from source level debugging information in the absolute object file.

The program development supporting apparatus according to the first embodiment of the present invention supports the development of the application program by outputting the function locating configuration file that instructs the compiler which function to which section to be located when the source file of the high-level language like C language is compiled and by outputting the link configuration file that instructs the section locating to the linker when linking.

The user determines the function located in the same relocatable section referring to the displayed call graph. The performance can be improved by locating the calling function and the called function to the same relocatable section as much as possible and thus reducing the number of memory overwrite for overlay.

Moreover, when actually locating to the memory, the setting when linking such as which section is absolute section that shares the same memory space and performs the memory overwrite, and which relocatable section composes the absolute section is edited (added and/or changed). As a result, the memory locating for the expected overlay can be created.

(Processing Procedure of Program Development Supporting Apparatus)

Processing procedure of the program development supporting apparatus according to the first embodiment of the present invention will be explained by using FIG. 2.

First of all, the source file of the high-level language like C language is analyzed to create the call graph, and information related to the call of the function is extracted. It may not analyze the source file by the program development supporting apparatus according to the first embodiment of the present invention. That is, information related to the call of the function may be analyzed by another program development supporting apparatus. The program development supporting apparatus according to the first embodiment of the present invention may extract the information related to the call from a file that another program development supporting apparatus outputs.

When the source file is analyzed, only the static call relation can be analyzed, which is determined before compilation. However, the dynamic call relation where the called function would change at the time of execution, such as function pointer calls, can be obtained can be obtained by collecting the call information on the function with the simulator at the time of execution. A dynamic call relation can be analyzed by inputting this information to the program development supporting apparatus according to the first embodiment of the present invention.

Moreover, since the data collected with the simulator might be imperfect, a function to read the file where the call relation is described by a constant format is necessary. Thus, call information on the input function is output as the call graph. The call graph displayed the call relations of functions in the target application program. It is a directed graph where a calling function and its called functions are connected.

Information on relocatable section to which the function is located from the source file of the high-level language like C language or the function locating configuration file to refer when the compiler locates the function besides the source file is input. The purpose of this is to know the current locating information on the function.

Thus, the section locating information of the input function is displayed. Moreover, the section locating information of the function is edited (added and/or changed), and the expected function locating can be set.

Moreover, the section locating information of a function edited as a result is output as the source file or the function locating configuration file. The relocatable object file to which the expected section is located is generated by compiling the source file again by using this file.

When linking, locating information on the section is input from the link configuration file where information on the locating of the relocatable section and information on the locating of the absolute section to match it to an actual memory organization etc. are described. And then, the locating information on this section is displayed. Moreover, the locating information on the relocatable section and the locating information on the absolute section are edited (added, changed, and/or deleted). And then, an editing result is output as the link configuration file. The application program to which the expected section is located can be created by creating the absolute object file from the relocatable object file again by using this file.

(Example of Display)

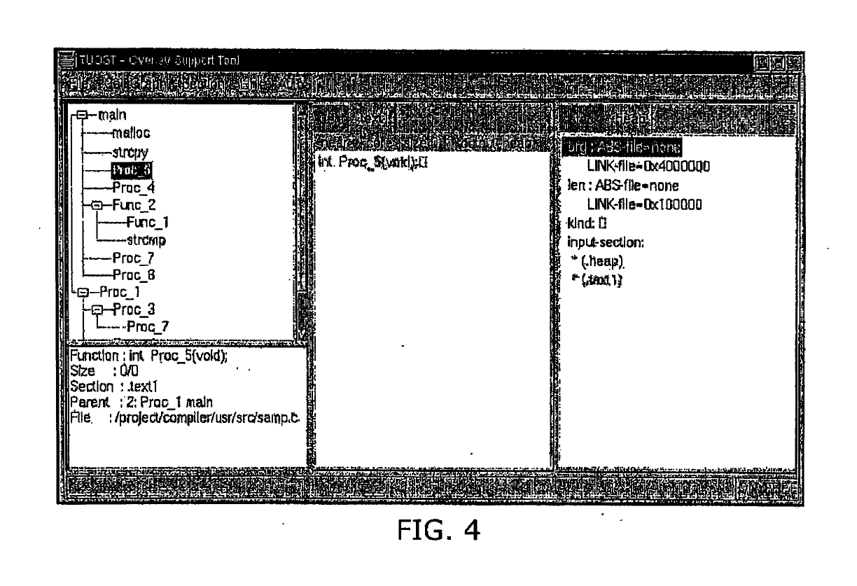

FIG. 4 shows the example of a display screen of the program development supporting apparatus according to the first embodiment of the present invention. The display screen is roughly divided into three fields. The field on the leftmost side is a field that displays information on the call graph and the selected function. The field at the center is a field that displays/edits information that shows which function is located to the relocatable section. The field on the part of the rightmost is a field that displays/edits information that shows which address is located to the absolute section and information that shows which relocatable section to be composed.

According to the program development supporting apparatus according to the first embodiment of the present invention, since the functions can be allocated to the relocatable sections in reference to the call graph, it becomes easy to edit the locating in developing the program executed on the processor of the limited instruction memory capacity. Moreover, since the section allocation for overlay can be set at the same time by editing the locating of the relocatable section and the absolute section, it becomes easy to develop the application program of the overlay system.

According to the program development supporting apparatus and method for operation of the program development supporting apparatus according to the first embodiment of the present invention, when the application for an embedded processor is developed, the section locating of the function and the memory locating of the section can generate/display/edit manually.

### Modified Example of the First Embodiment

Specifying all the source file names for the program development supporting apparatus according to the first embodiment of the present invention becomes complex when there are plural source files to create the application program.

In the program development supporting apparatus according to the modification example of the first embodiment of the present invention, the source file name needs not to be specified by using a source file name from the source level debugging information in the absolute object file after linking. Therefore, since the user specifies only the file name of the absolute object file, the facility increases. Furthermore, the code sizes of each function included in the source level debugging information are extracted, and then these are displayed. The code size information on each function is used when the section locating of the function is decided.

According to the program development supporting apparatus according to the modification example of the first embodiment of the present invention, the absolute object file input analysis function that extracts the information on the file name of the source file, the section information, and the function size from the source level debugging information in the absolute object file is added. As a result, specifying name of the source file is not necessary, and displaying the size of the actual function and the size of the actual section becomes possible.

### Second Embodiment

Hereafter, the mechanism that automatically determines the code locating in overlay will be described in the second embodiment of the present invention.

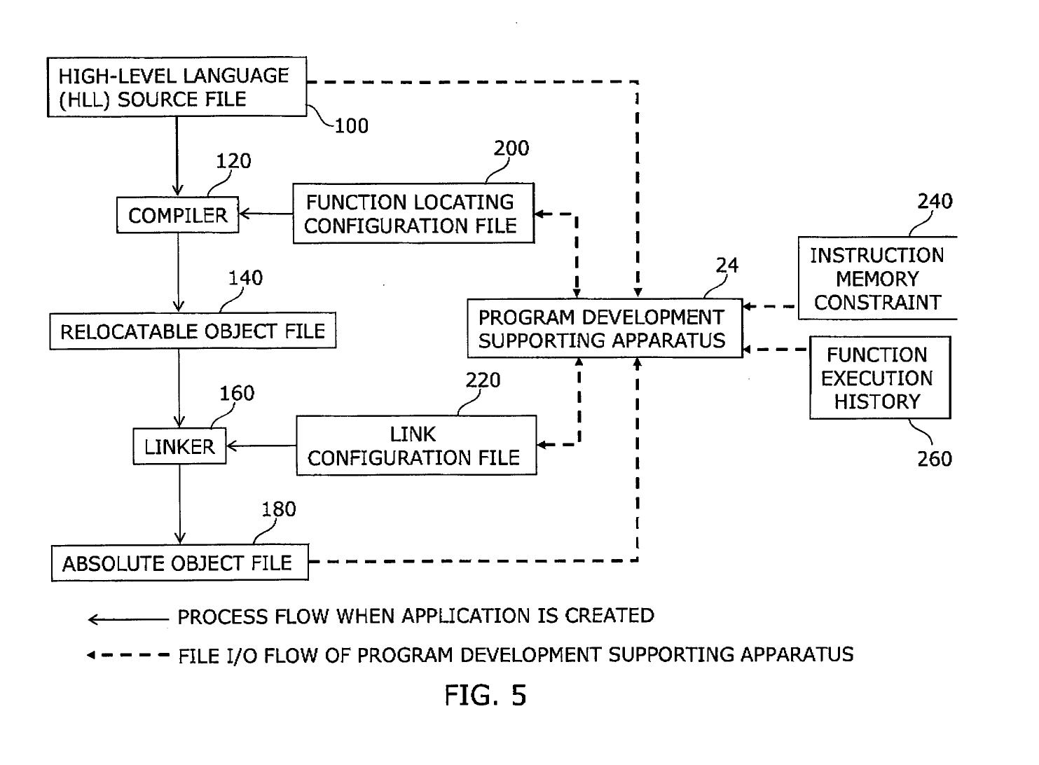

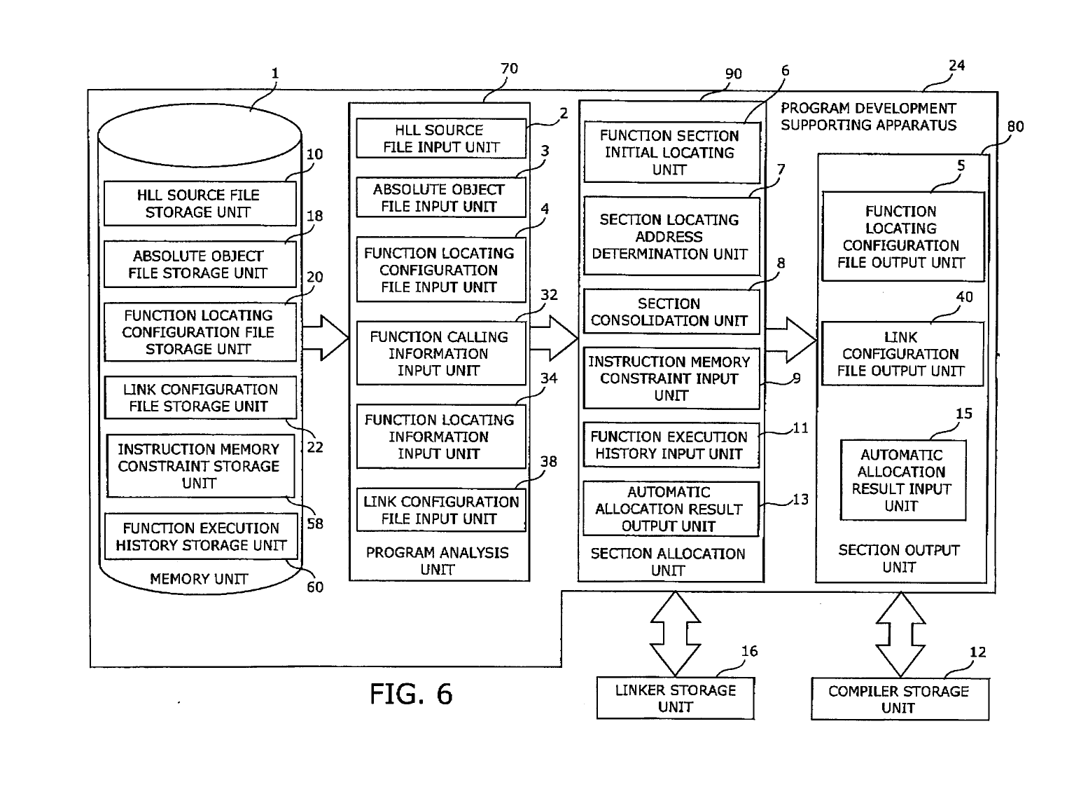

As shown in FIG. 5, a program development supporting apparatus according to the second embodiment of the present invention cooperates with a High-Level Language (HLL) source file 100, a compiler 120, a relocatable object file 140, a linker 160, an absolute object file 180, a function locating configuration file 200, a link configuration file 220, an instruction memory constraint 240, and a function execution history 260.

In FIG. 5, solid line arrows show a process flow when application is created. Moreover, in FIG. 5, the dotted line arrows show an I/O flow of each file of the program development supporting apparatus.

As shown in FIG. 5, the program development supporting apparatus 24 according to the second embodiment of the present invention includes a memory unit 1, a program analysis unit 70 configured to analyze a program, a section allocation unit 90 configured to obtain allocation of program code to an instruction memory area, a section output unit 80 configured to output the allocation of program code obtained by the section allocation unit 90 to the instruction memory area. A linker storage unit 16 and a compiler storage unit 12 are provided outside.

The memory unit 1 includes a High-Level Language (HLL) source file storage unit 10, an absolute object file storage unit 18, a link configuration file storage unit 22, an instruction memory constraint storage unit 58, and a function execution history storage unit 60. The HLL source file storage unit 10 stores an HLL source file. The absolute object file storage unit 18 stores an absolute object file, and extracts information of the source file, section information, and the function size from source level debugging information in the absolute object file. The function locating configuration file storage unit 20 stores a function locating configuration file. The link configuration file storage unit 22 stores a link configuration file. The instruction memory constraint storage unit 58 stores an instruction memory constraint.

The program analysis unit 70 includes an HLL source file input unit 2, an absolute object file input unit 3, a function locating configuration file input unit 4, a function calling information input unit 32, a function locating information input unit 34, and a link configuration file input unit 38. The HLL source file input unit 2 inputs the HLL source file stored in the HLL source file storage unit 10. The absolute object file input unit 3 inputs the absolute object file stored in the absolute object file storage unit 18. The function locating configuration file input unit 4 inputs the function locating configuration file stored in the function locating configuration file storage unit 20. The Function calling information input unit 32 inputs a call relation of the function from the source file. The function locating information input unit 34 inputs locating information from the function locating information file to the relocatable section of the function. The link configuration file input unit 38 inputs locating information on the absolute section from a configuration file used when linking.

The section allocation unit 90 includes a function section initial locating unit 6, a section locating address determination unit 7, a section consolidation unit 8, an instruction memory constraint input unit 9, a function execution history input unit 11, and an automatic allocation result output unit 13. The function section initial locating unit 6 receives data from the program analysis unit 70, and allocates all functions to the distinct sections. The section locating address determination unit 7 determines a location address of all sections from a function call graph. The section consolidation unit 8 consolidates the section between function of parent and child and between function of preceding sibling and following sibling on the function call graph. The instruction memory constraint input unit 9 inputs the instruction memory constraint stored in the instruction memory constraint storage unit 58. The function execution history input unit 11 inputs the function execution history stored in the function execution history storage unit 60. The Automatic allocation result output unit 13 outputs an automatic allocation result to the section output unit 80.

The section output unit 80 includes a function locating configuration file output unit 5, a link configuration file output unit 40, and an automatic allocation result input unit 15. The function locating configuration file output unit 5 receives data from the section allocation unit 90, and outputs the function locating configuration file. The link configuration file output unit 40 outputs locating information on the relocatable section and the absolute section. The automatic allocation result input unit 15 inputs the automatic allocation result from the automatic allocation result output unit 13.

Alternatively, in the program development supporting apparatus according to the second embodiment of the present invention, the program analysis unit 70 obtains the function call graph of the program or the program, and the section allocation unit 90 obtains the allocation of the program code to the instruction memory area based on the function call graph.

The file/data read and written in program development supporting apparatus 24 are the HLL source file 100, the absolute object file 180, the function locating configuration file 200, the link configuration file 220, the instruction memory constraint 240, and the function execution history 260. These data and all part of the program development supporting apparatus 24 are in the following relations.

The program analysis unit 70 inputs the HLL source file 100, the absolute object file 180, the function locating configuration file 200 and the link configuration file 220, and passes the analytical result (function call graph and function size) to the section allocation unit 90.

The section allocation unit 90 inputs the above-mentioned analytical result, the instruction memory constraint 240, and the function execution history 260, outputs the automatic allocation result (locating to the section of the function and locating to the memory of the section), and passes to the section output unit 80.

The section output unit 80 outputs the automatic allocation result mentioned above as the function locating configuration file 200 and the link configuration file 220. As for the link configuration file 220, data that adds the automatic allocation result to the input file is an output file.

Alternatively, in the program development supporting apparatus 24 according to the second embodiment of the present invention, the section allocation unit 90 obtains an allocation of the program code to the instruction memory area based on the function call graph.

Alternatively, in the program development supporting apparatus 24 according to the second embodiment of the present invention, the section allocation unit 90 inputs a function execution history that is the function calling sequence at the program execution, and then obtains the allocation of the program code to the instruction memory area. The function execution history 260 is used to obtain the allocation by being added to the function call graph and the function size.

Alternatively, in the program development supporting apparatus 24 according to the second embodiment of the present invention, the section allocation unit 90 allocates sets of functions that specified by the user to the same section of program.

FIG. 5 shows the relation of the files that the program development supporting apparatus 24 according to the second embodiment of the present invention inputs and outputs, and other tools for creating the application program.

The Program development supporting apparatus 24 according to the second embodiment of the present invention analyzes the application program described in the high-level language such as C language for the embedded processor based on the description contents of the program, the function call graph (call path of the function) and the executing contents. And then, by automatically determining the allocation of each function to the relocatable section and the locating of the relocatable section on the memory, the locating of the program code on the instruction memory is automatically determined. Moreover, definition information on the section that contains those functions is automatically generated.

The program development supporting apparatus 24 according to the second embodiment of the present invention automatically generates and outputs the function locating configuration file to instruct which function to which section to be located when the source file of the high-level language like C language is compiled, and the link configuration file to instruct the section locating to the linker at the program linkage.

The program development supporting apparatus 24 according to the second embodiment of the present invention reduces the number of memory overwrite for overlay by attempting to allocate a certain function and the function that calls it in the program to the same relocatable section as much as possible, and improves the program execution performance. It is possible to overlay within the range of the size restriction of the given instruction memory by compiling and linking the application programs again by using the function locating configuration file and the link configuration file generated like this, and then the application program that the memory overwrite is fewer can be obtained.

The program development supporting apparatus 24 according to the second embodiment of the present invention inputs the HLL source file of the program described in the high-level language like C language and the absolute object file made executable by compiling and linking the program.

The Program development supporting apparatus 24 according to the second embodiment of the present invention further may input the link configuration file to specify to which area on the address space the relocatable section that is the unit that treats each function in the program collectively on the memory is located.

Moreover, the program development supporting apparatus 24 according to the second embodiment of the present invention inputs the start address and the size of instruction memory constraint 240 that can be used for the program execution. The start address and the capacity of instruction memory constraint 240 may be explicitly specified from the outside by the user, or may be obtained by analyzing the memory map on the link configuration file.

(Flow Chart Explaining Entire Processing Procedure)

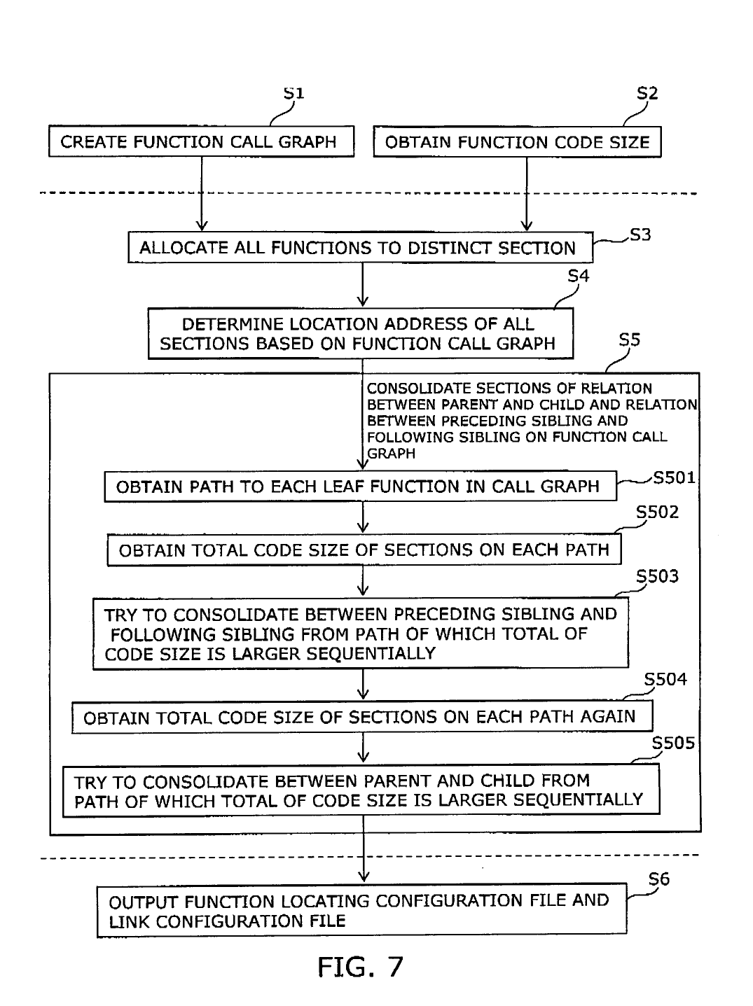

The procedure executed by the program development supporting apparatus 24 according to the second embodiment of the present invention which generates the allocation information to the section of each function and definition information on each section from the program and other input information is shown in FIG. 7. In the following steps, Step S1 to Step S2 correspond to the operations in the program analysis unit 70, Step S3 to Step S5 correspond to the operations in the section allocation unit 90, and Step S6 corresponds to the operation in the section output unit 80.

(Program Analysis Unit)

In the program analysis unit 70, information needed in the section allocation unit 90 is extracted and composed from the HLL source file storage unit 10 of the program given as input and the absolute object file storage unit 18.

(a) In Step S1, the function call graph is created from the High-Level Language (HLL) source file of the program stored in the HLL source file storage unit 10 of the program.

The function call graph is the directed graph that considers an individual function under the program to be one node, and connects between nodes of a certain function and its child function (a function which is called from the certain function) with an edge.

(b) Next, in Step S2, the code size of each function is obtained from the absolute object file stored in the absolute object file storage unit 18 of the program.

The code size of the function is needed when the function is allocated to the section by the section allocation unit 90 and the section is located on the address space of the instruction memory constraint storage unit 58.

(Section Allocation Unit)

The section is a minimum unit at the time when the code and data are located on the memory of the processor. The section includes the relocatable section that can locate to the arbitrary address and the absolute section with the location address as a value.

The locating to the address on the memory of the relocatable section is decided by the description of the absolute section and the correspondence of the relocatable section located to each absolute section in the link configuration file stored in the link configuration file storage unit 22.

In the following, it assumed to be always in the one-on-one relationship between the relocatable section and the absolute section corresponding to it. Moreover, the relocatable section and the absolute section corresponding to it are collectively only called “Section” as long as it does not explain especially.

The section allocation unit 90 determines allocation of each function in the program to the section and allocation of each section to address of processor's memory, based on the function call graph created by the program analysis unit 70.

Although various methods are considered to the allocation of the function to the section, the method of using the section consolidation of the function of parent and child and the function of preceding sibling and following sibling of the function call graph will be explained here.

(c) Next, in Step S3, all functions are allocated to the distinct section respectively as initial state A_init.

(d) Next, in Step S4, the location address of all sections is determined based on the function call graph.

The location address on instruction memory constraint 240 of each section is determined as follows.

(d1) The function that is not called from other functions is retrieved on the function call graph. This function is called “root function”. The root function is usually a function that is called at the beginning of the program.

(d2) The section of the root function is located to the start address of the instruction memory constraint 240 given by the input.

(d3) The section of the individual child function that is called from the root function is located to the address of the immediate aftermath of the section of the root function respectively.

(d4) The section of each function is located to the address of the immediate aftermath of the section of the function (parent function) that calls the function according to a similar procedure as follows. For the section of the function with two or more parent functions, one section with the largest address of the section tall is chosen from among sections of the parent function, and it locates to the address of the immediate aftermath.

Thus, by determining the location address of each section, when a certain function is executed, the section of the parent function of the executing function and the section of all functions that furthermore go back to upper the call relation of the function can be located to the addressing area that does not overlap with the section of the function executed now.

(e) Next, in Step S5, consolidating of the section between function of parent and child and between function of preceding sibling and following sibling is tied on the function call graph.

In initial state A_init, all functions are allocated in the distinct section. In this case, overwriting a section of a function to memory by overlay is needed every time a new function is called at program execution, and it causes the performance degradation of the program.

Therefore, it is preferable to allocate both of a certain function and the child function called there to the same section. Moreover, it is also preferable to allocate multiple functions which are subsequently called to the same section. On the other hand, all functions cannot be allocated to a single section since there is a limitation in the size of the instruction memory that can be used. Then, by choosing some of the combinations of functions and merging with the same section based on the call graph of the program, the code size of the function, and the size of instruction memory constraint 240, multiple sections should be merged in one within the range where the constraint of the size of instruction memory constraint 240 is not exceeded.

Although various methods are considered as for merging of the section, a method to merge sections for each path tracing from the root function to leaf function of the call graph is explained here, where paths are chosen in order of total size of sections on the path and section of a function and its adjacent function's sections on that path are chosen and are merged.

(e1) In Step S501, Path P(F_root, . . . , F_leaf) from root function F_root to individual leaf function F_leaf is obtained in the call graph.

The leaf function F_leaf is a function that does not call other functions (child function) from the function itself, or a function that all the child functions called from the function are in the path P(F_root, . . . , F_leaf).

(e2) Next, in Step S502, the total of the code size of the section of each function of each path is obtained.

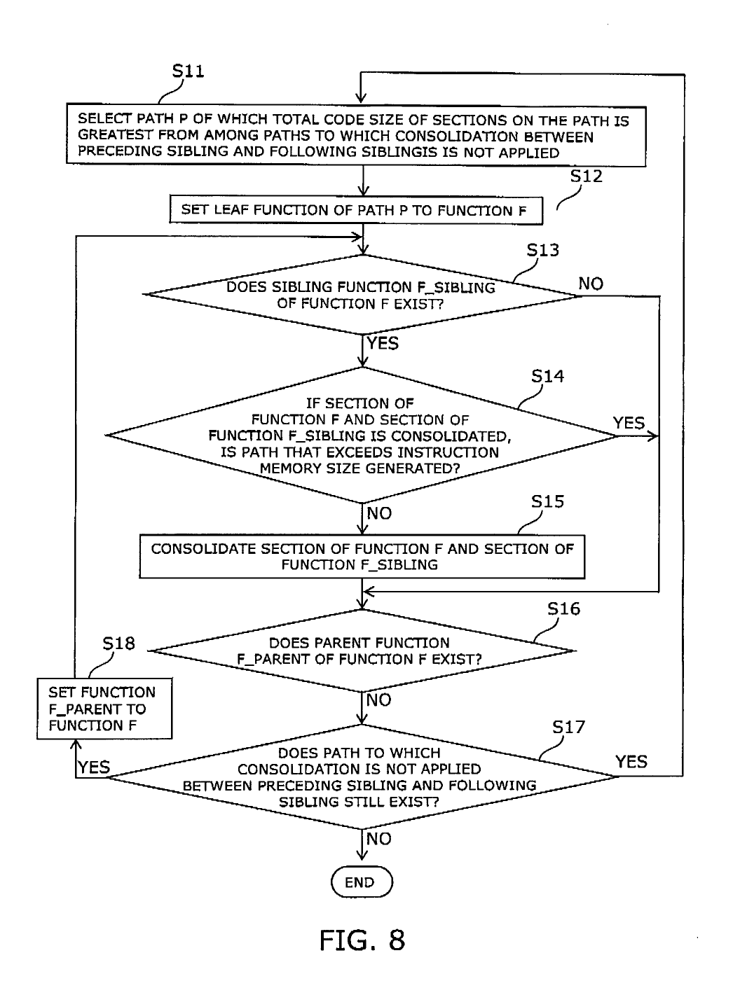

(e3) Next, in Step S503, consolidating between preceding sibling and following sibling is sequentially tried from the path with a large total of the code size. The consolidating between preceding sibling and following sibling will be explained later referring to FIG. 8.

(e4) Next, in Step S504, total of the code size of each path is obtained again.

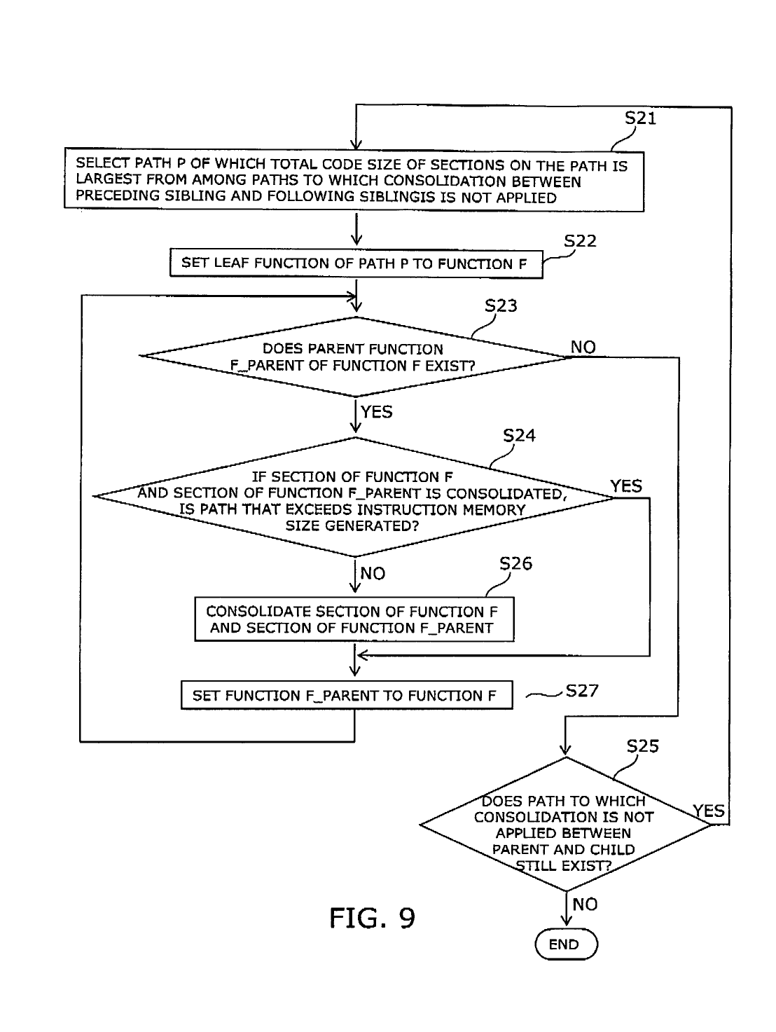

(e5) Next, in Step S505, consolidating between parent and child consolidating is sequentially tried from the path with a large total of the code size. The consolidating between parent and child will be explained later referring to FIG. 9.

(Section Output Unit)

As for all functions in the program, in section allocation unit 90, the section that located the function and the location address on the instruction memory constraint 240 of the section have been determined.

(f) Next, in Step S6, the section output unit 80 outputs the correspondence of the function and the section to the function locating configuration file storage unit 20. Moreover, the section output unit 80 outputs the location address on the instruction memory constraint 240 of the section to the link configuration file storage unit 22.

(Consolidating Between Preceding Sibling and Following Sibling)

Processing listed below is sequentially executed for each path, from the one that the total of code size is largest.

When sibling function F_sibling of function F for each function F on the path exists, the consolidation process will be applied from the leaf function in order as follows. The sibling function F_sibling is a function that is called from the same parent function on the call graph and is called by just before or just after the call location of function F in the definition of the parent function in the high-level language file.

When a sibling function F_sibling for function F exists, consolidating of section S(F) of F and section S(F_sibling) of F_sibling is tried. That is, all functions that belong to S(F) and all functions that belong to S(F_sibling) are located to one new section S_new. And then, when the address of S_new is located to an address that is larger than the address of S(F) and the address of S(F_sibling), if the size of all paths including S_new does not exceed the constraint of the instruction memory, new section S_new that consolidates S(F) and S(F_sibling) is created.

The location address of S_new is determined as well as the location address of the section with multiple parent functions. That is, it locates to the immediate aftermath of the section of a parent function where the tail of the location address is the greatest excluding the S_new itself.

In the program development supporting apparatus according to the second embodiment of the present invention, processing procedure of consolidating between preceding sibling and following sibling will be explained by using FIG. 8.

(a) In Step S11, path P where the code size total of the section corresponding to each function of the path is the greatest is selected from among paths to which consolidating between preceding sibling and following sibling is not applied.

(b) Next, in Step S12, function F is set to the leaf function of path P.

(c) Next, in Step S13, it is determined whether or not sibling function F_sibling of function F exists. As a result of Step S13, if sibling function F_sibling of function F exists, this processing goes to Step S14. As a result of Step S13, if sibling function F_sibling of function F does not exist, this processing goes to Step S16.

(d) Next, in Step S14, it is determined whether or not the path that exceeds the instruction memory size is generated if sections of function F and sibling function F_sibling are consolidated. As a result of Step S14, if the path that exceeds the instruction memory size is generated when function F and the section of sibling function F_sibling are consolidated, this processing goes to Step S16. On the other hand, as a result of Step S14, if the path that exceeds the instruction memory size is not generated when function F and the section of sibling function F_sibling are consolidated, this processing goes to Step S15.

(e) Next, in Step S15, the section of function F and the section of sibling function F_sibling are consolidated.

(f) Next, in Step S16, it is determined whether or not parent function F_parent of function F exists. As a result of Step S16, if parent function F_parent of function F exists, this processing goes to Step S18. On the other hand, as a result of Step S16, if parent function F_parent of function F does not exist, this processing goes to Step S17.

(g) Next, in Step S17, it is determined whether or not the path to which consolidating between preceding sibling and following sibling is not applied exists. As a result of Step S17, if the path to which consolidating between preceding sibling and following sibling is not applied exists, this processing returns to Step S11. On the other hand, as a result of Step S17, if the path to which consolidating between preceding sibling and following sibling is not applied does not exist, this processing is ended.

Next, in Step S18, function F is set to parent function F_parent, and then this processing goes to Step S13.

(Consolidating Between Parent and Child)

Processing listed below is sequentially done from the one that the total of code size large to each path.

When parent function F_parent of function F exists, each function F of the path is sequentially processed from the leaf function as follows. That is, if the size of all paths including S_new does not exceed the constraint of the instruction memory when two sections S(F) and S(F_parent) are consolidated and new section S_new is created, new section S_new that consolidates S(F) and S(F_parent) is created.

The location address of S_new locates to the immediate aftermath of the section where the tail of the location address is the greatest from among sections of all parent functions that belong to S_new as well as the case of consolidating between preceding sibling and following sibling.

Here, processing procedure of the consolidating between parent and child in the program development supporting apparatus according to the second embodiment of the present invention will be explained by using FIG. 9.

(a) In Step S21, path P where the total of the code size of the section on the path is the greatest is selected from among paths to which the consolidating between parent and child is not applied.

(b) Next, in Step S22, function F is set to the leaf function of path P.

(c) Next, in Step S23, it is determined whether or not parent function F_parent of function F exists. As a result of Step S23, if parent function F_parent of function F exists, this processing goes to Step S24. On the other hand, as a result of Step S23, if parent function F_parent of function F does not exist, this processing goes to Step S25.

(d) Next, in Step S24, it is determined whether or not the path that exceeds the instruction memory size is generated when sections of function F and parent function F_parent are consolidated. As a result of Step S24, if the path that exceeds the instruction memory size is generated when function F and the section of parent function F_parent are consolidated, this processing goes to Step S27. On the other hand, as a result of Step S24, if the path that exceeds the instruction memory size is not generated even when function F and the section of parent function F_parent are consolidated, this processing goes to Step 526.

(e) Next, in Step S25, it is determined whether or not the path to which the consolidating between parent and child is not applied exists. As a result of Step S25, if the path to which consolidating between parent and child is not applied exists, this processing goes to Step S21. On the other hand, as a result of Step S25, if the path to which consolidating between parent and child is not applied does not exist, this processing is ended.

(f) Next, in Step S26, the section of function F and the section of parent function F_parent are consolidated.

(g) Next, in Step S27, function F is set to parent function F_parent, and then this processing goes to Step S23.

(Call Graph of Program P1)

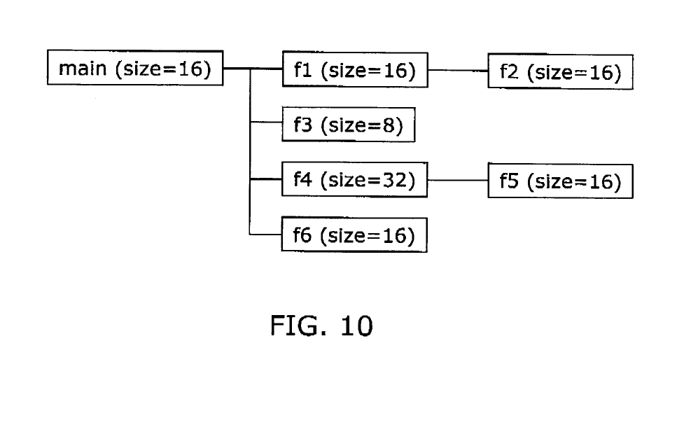

In the program development supporting apparatus according to the second embodiment of the present invention, the call graph of program P1 is shown schematically in FIG. 10.

Hereafter, the example of applying the allocation of the above-mentioned function section to program P1 shown in FIG. 10 will be explained.

Program P1 is a program including seven functions (function main, function f1, function f2, function f3, function f4, function f5, and function f6). The call graph where the call relations among functions is shown in FIG. 10.

Here, the program is executed in the following order.

(a1) Function main is executed.

(a2) Function f1 is called from function main.

(a3) Function f2 is called from function f1.

(a4) Executing function f1 ends after executing function f2 ends, and then the control returns to function main.

(a5) Function f3 is called.

(a6) Function f4, function f5, and function f6 are called respectively according to the same procedure.

(a7) Finally, the control returns to function main, and then the entire executing ends.

Here, the start address of instruction memory constraint 240 is assumed to be 0x200000, and the size that can be used is assumed to be 64 bytes.

The procedure for applying the function section automatic allocation of the program development supporting apparatus according to the second embodiment of the present invention to this program is as follows. The following Step S1 to Step S6 is corresponding to each step as shown in FIG. 7.

[a] (Step S1) The call graph is created from the HLL source file of program P1.

[b] (Step S2) The code size of each function of program P1 is obtained.

Here, the code size of each function is assumed that function f3 is 8 bytes, function f4 is 32 bytes, and other functions are 16 bytes.

[c] (Step S3) The section corresponding to each function is created. Here, the function that each section belongs is expressed by bundling by “{” and “}” for allocating the function and the section.

Then, initial state A_init is shown as follows:
A_{—init=[{main}, {f}1}, {f2}, {f3}, {f4}, {f5}, {f6}].

[d] (Step S4) The location address of each section is determined.

Here, firstly, the address of section S(main) of root function main is located to start address 0x200000 of the given instruction memory.

Next, the start address of S(f1), S(f3), S(f4) and S(f6) that are each section of the child function of function main is located to address 0x200010 of the immediate aftermath of S(main). Next, section S(f2) of the child function of function f1 is located to 0x200020, and section S(f5) of the child function of function f4 is located to 0x200030.

[e] (Step S5) Sections are consolidated on the basis of the call graph.

First of all, the path to each leaf function and the size of each path are obtained from the root function on the basis of Step S501 and Step S502 processing.

Here, the following four paths are obtained:

| | | |
|---|---|---|
| P(main, f1, f2) | = [{main} {f1} {f2}] | (size = 48 bytes), |
| P(main, f3) | = [{main} {f3}] | (size = 24 bytes), |
| P(main, f4, f5) | = [{main} {f4} {f5}] | (size = 64 bytes), |
| P(main, f6) | = [{main} {f6}] | (size = 32 bytes). |

[f] (Step S503) It sequentially consolidates between preceding sibling and following sibling from the one that the size large among paths obtained by [e].

First of all, function of preceding sibling and following sibling f3 and f6 exist in function f4 about path P(main,f4,f5) of the size of the greatest. However, since the size of P(f5) equal to 64 bytes that are the sizes of the instruction memory, even if either of the section of sibling function f3 and f6 is consolidated in the section of function f4, the upper limit of the size of the instruction memory is exceeded. Therefore, consolidating between preceding sibling and following siblings is not executed.

Sibling function f3 exists in function f1 about path P(main, f1,f2), where the size of the path is the largest in unprocessed paths. If S(f3) and S(f1) are consolidated, P(main, f1, f2) is shown as follows and the size is 56 bytes:
P(main,f1,f2)=[{main}(16 bytes), {f1,f3}(24 bytes), {f2}(16 bytes)].
Since this is smaller than the size upper limit of the instruction memory, S(f3) and S(f1) are consolidated.

Function of preceding sibling and following sibling f4 is the candidate of consolidating about path P(main,f6) of which size is the largest among the remaining paths. However, since the path of P(main, f4, f5) including S(f4) exceeds the size upper limit of the instruction memory when consolidating, it is not consolidated.

Since function f3 has already been consolidated in the same section as function f1 about the last paths P(main, f3), the path of the maximum size including this section is P(main, f1, f2). Since P(main, f4, f5) still exceeds the upper limit of the size of the instruction memory when section S(f4) of f4 that is the sibling function of function f3 is consolidated in this path, it is not consolidated.

Consequently, S(f1) and S(f3) are consolidated, and the function section allocating is shown as follows:
A=[{main} {f1,f3}{f2}{f4},{f5}{f6}].

[g] (Step S504) Once again, the total of code size of each path is obtained, and the application of the consolidating between parent and child is tried.

S(f4) and S(f5) can be consolidated about the path P(main, f4, f5)=[{main}, {f4}, {f5}] whose size is the greatest. In this case, the size of P(main, f4, f5) does not increase. Since other paths (P(main, f1, f2)) exceed the size upper limit when consolidating S(main) and S(f4), it is not consolidated.

S(f1) and S(f2) can be consolidated about the path P(main,f1,f2)=[{main}, {f1, f3}, {f2}] whose size is the largest in the remaining paths. Since other paths (P(f5)) exceed the size upper limit about S(main) and S(f1) as well as the above-mentioned, it is not consolidated.

Path P(main,f3) and P(main,f6) of the remainder similarly, since other paths exceed the size upper limit by consolidating S(main), S(f3) and S(f6), it is not consolidated.

Consequently, S(f1), S(f2), S(f4) and S(f5) are consolidated respectively. As a result, the function section allocating is shown as follows, and can locate seven functions to four sections within the range of the size restriction of the instruction memory:
A=[{main} {f1,f2,f3}{f4,f5}{f6}]
(Result of Function Section Allocating of Program P)

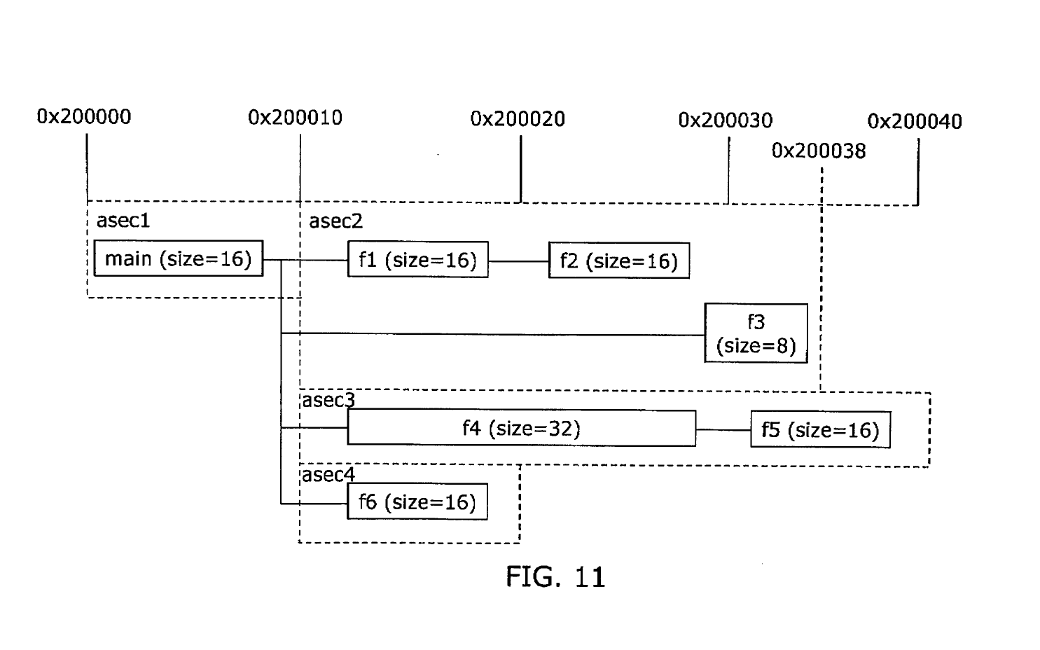

In the program development supporting apparatus according to the second embodiment of the present invention, a result of the function section allocating of program P is shown schematically in FIG. 11.

Here, the relocatable section of function main is assumed to be rsec1 and the absolute section is assumed to be asec1. Similarly, the section of function f1, function f2, and function f3 is assumed to be rsec2/asec2, the section of function f4 and function f5 is assumed to be rsec3/ase3, and the section of function f6 is assumed to be rsec4/asec4. As a result, asec1 is located to start address 0x200000 of the specified instruction memory. Moreover, asec2, asec3, and asec4 are located to address 0x200010 of the immediate aftermath of the section of parent function main that each section contains.

By the result of allocation described above, overwrite along the start address and the size of the specified instruction memory is possible since the section corresponding to the function is transmitted from external storage to the instruction memory. Immediately before either of functions of each section is executed at program execution. That is, section asec1 is transmitted to the instruction memory immediately before function main is called, and then it only has to transmit section asec2, asec3, and asec4 respectively to the instruction memory immediately before function f1, function f4, and function f6 are called firm function main.

[h] (Step S6) Allocating the function determined by [g] to the section is output to the function locating configuration file. Moreover, allocating on the instruction memory of the section to the address is output to the link configuration file.

(Function Locating Configuration File)

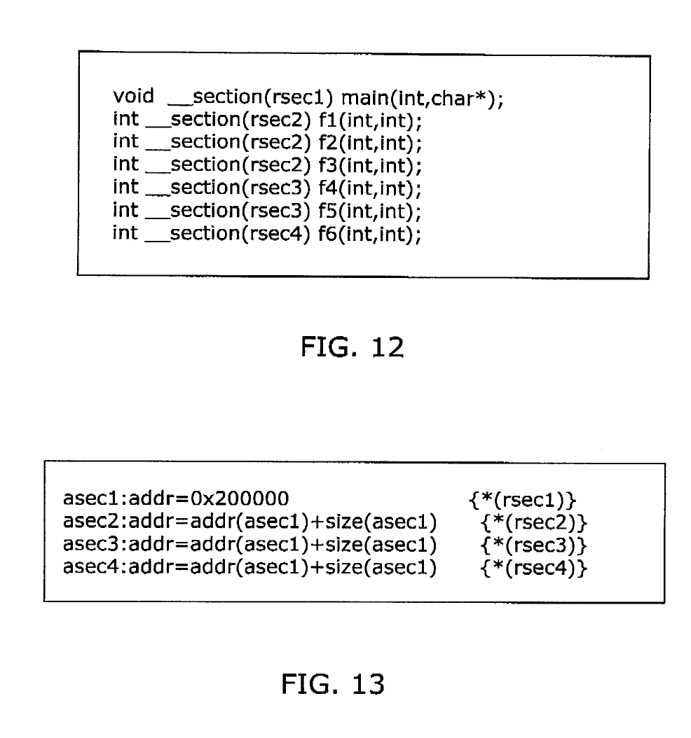

In the program development supporting apparatus according to the second embodiment of the present invention, the function locating configuration file corresponding to the function section automatic allocation result of program P is shown schematically in FIG. 12.

The function locating configuration file of FIG. 12 has enhanced the notation of the function prototype declaration of C language. The relocatable section for the function is specified by _section( ) qualification of the function prototype declaration.

It is reflected in the application program to which the specification of the section is generated by recompiling the sourcefile of the program by using the C compiler corresponding to enhancing the _section( ) qualification.

(Link Configuration File)

In the program development supporting apparatus according to the second embodiment of the present invention, the link configuration file corresponding to the function section automatic allocation of program P is shown schematically in FIG. 13.

In the link configuration file of FIG. 13, address (addr) of the instruction memory of asec1 is specified for 0x200000. Although the address of the instruction memory of asec2, asec3 and asec4 assumes the tail address of asec1, here, not absolute address but the relative address that uses operator addr (asec1) that shows the address of the instruction memory of asec1 and operator size (asec1) that shows the size of the section of asec1 is specified. Even when the code size of function main changes by the code modification, it is possible to use the same link configuration file by using such relative addressing operators.

According to the program development supporting apparatus according to the second embodiment of the present invention, in the development of the program that operates on the processor of the limited instruction memory capacity, by using the program itself as an input, the allocation of program's instruction codes to memory area specified by instruction memory size constraint can be automatically obtained, where the program uses the instruction memory efficiently with decreased overhead of overlay.

### Third Embodiment

In the program development supporting apparatus according to the second embodiment of the present invention, the method of consolidating sections based on the structure of the function call graph of the program has been explained about the section allocation unit 90. The purpose of the section consolidation is to locate the plural function executed continuously in the range of the constraint of the instruction memory size to the same section as much as possible, and to decrease the overhead of the memory overwrite by overlay. However, it is also possible to use data other than the structure of the function call graph.

For example, if the program execution environment with Instruction Set Simulator (ISS) etc. already exists, the program can be actually executed, and, as a result, the frequency of the call and the transition between functions at the time of executing can be obtained. In addition to the function call graph of the program, the function section allocation with execution results of the program is considered and the allocation with smaller overlay overhead can be generated by explicitly giving these specification to the program development supporting apparatus according to the second embodiment of the present invention as input.

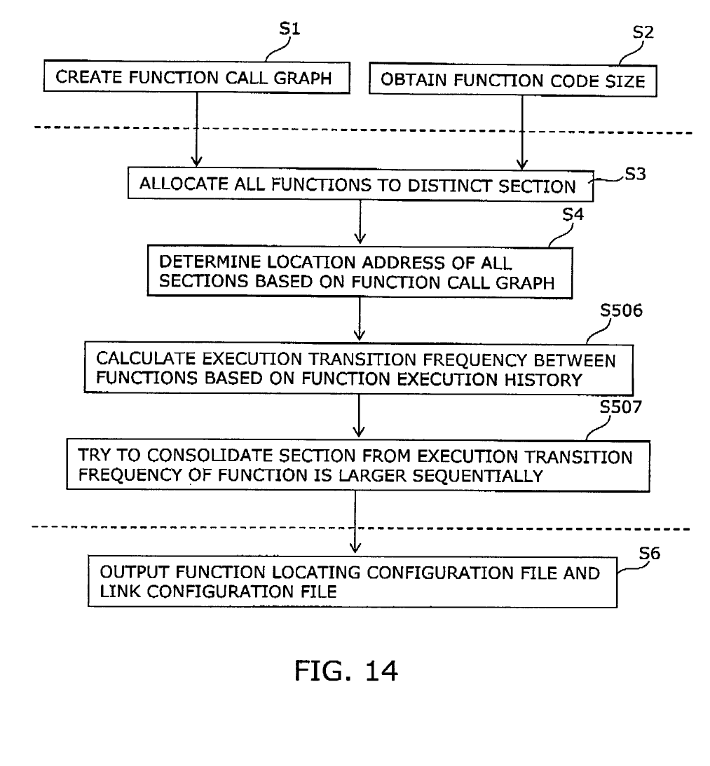

Hereafter, a method that the function execution history based on the program execution result is given to the section allocation unit 90 as input, and a method of allocating the function to the section with the execution result and determining the locating to the address of the section will be explained (Refer to FIG. 14). In addition, the parts other than section allocating unit 90 are assumed to be similar to the composition of the program development supporting apparatus according to the second embodiment of the present invention.

(Flow Chart Explaining Entire Processing Procedure)

In a program development supporting apparatus according to the third embodiment of the present invention, the flow chart which explains the entire processing procedure is indicated as shown in FIG. 14. In FIG. 14, Step S1 to Step S2 corresponds to operating in the program analysis unit 70, Step S3 to Step S507 corresponds to operating in the section allocation unit 90, and Step S6 corresponds to operating in the section output unit 80. Hereafter, only operating different from the second embodiment of the present invention will be explained.

(Section Allocation Unit)

(a) In Step S506, the execution transition frequency between functions is calculated based on the function execution history. Here, the call from the parent function to the child function is counted with one count, and the executing transition between function of preceding sibling and following sibling is counted with one count. Here, the definition of the function of preceding sibling and following sibling is assumed to be “Combination of two functions executed being called from the same parent function, and continuously” unlike the program development supporting apparatus according to the first embodiment of the present invention. That is, when two functions which have the same parent function are executed continuously regardless of the appearance order on the HLL source file, it is considered as a function of preceding sibling and following sibling.

Moreover, when executing changes in the opposite direction between two functions, those execution transition frequencies are added up. That is, the execution transition frequency between A and B is counted as 19 when changing from function A to function B ten times, and changing from function B to function A nine times.

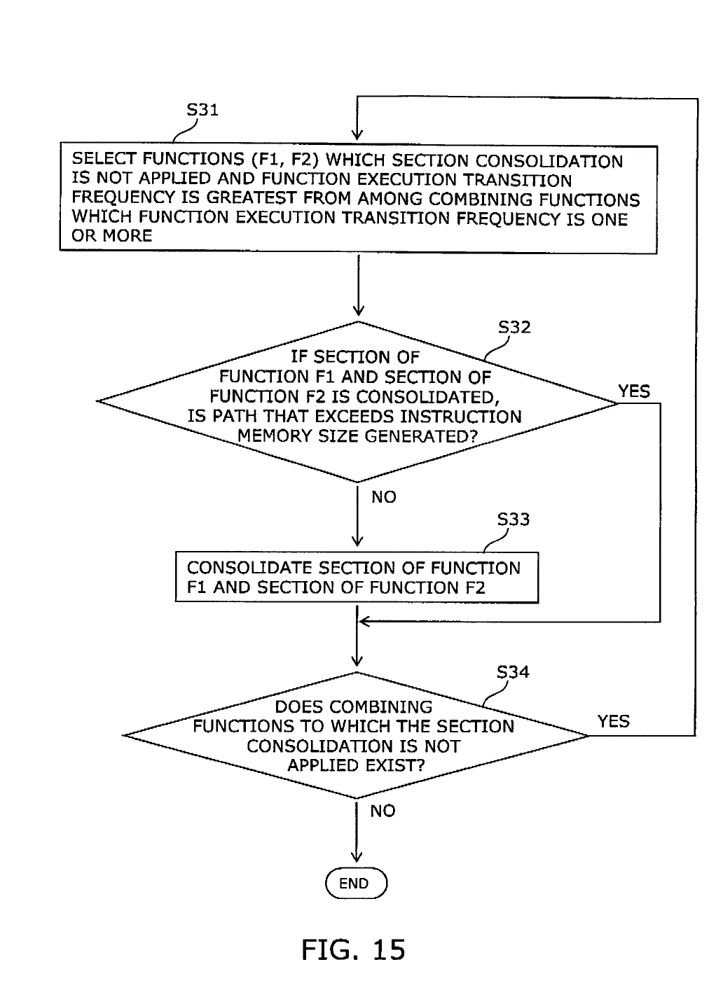

(b) Next, in Step S507, the section consolidation is executed to each section in initial state A_init based on the execution transition frequency between functions calculated in Step S506 (Refer to FIG. 15). More specifically, consolidating of the section to which both functions belong is sequentially tried from the combination of functions with the largest execution transition frequencies. At this time, as well as the case in Step S5 in FIG. 7, only when the size of the path of the size the greatest including a new section does not exceed the size restriction of the instruction memory when a new section that consolidates two sections is created, the sections are consolidated.

(Processing Procedure of Section Consolidation based on Function Call Frequency)

In the program development supporting apparatus according to the third embodiment of the present invention, the flow chart that shows processing procedure of the section consolidation based on the function call frequency is shown in FIG. 15.

(a) In Step S31, Function pair (F1, F2) which section consolidation is not applied and function execution transition frequency is greatest is selected from among combining functions which function execution transition frequency is one or more.

(b) Next, in Step S32, it is determined whether or not the path that exceeds the instruction memory size is generated if the sections of function F1 and function F2 are consolidated. As a result of Step S32, when the path that exceeds the instruction memory size is generated if the sections of function F1 and function F2 are consolidated, this processing goes to Step S34. On the other hand, as a result of Step S32, when the path that exceeds the instruction memory size is not generated if the sections of function F1 and function F2 are consolidated, this processing goes to Step S33.

(c) Next, in Step S33, the section of function F1 and the section of function F2 are consolidated.

(d) Next, in Step S34, it is determined whether or not the combination of functions to which the section consolidation is not applied exists. As a result of Step S34, when the combination of functions to which the section consolidation is not applied exists, this processing returns to Step S31. On the other hand, as a result of Step S34, when the combination of functions to which the section consolidation is not applied does not exist, this processing is ended.

(Program P2)

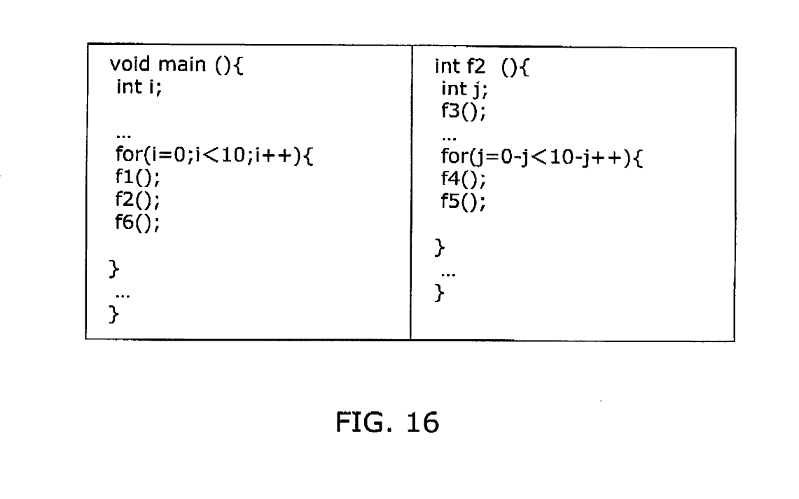

In the program development supporting apparatus according to the third embodiment of the present invention, program P2 is expressed as shown schematically in FIG. 16. Hereafter, the example of applying the above-mentioned section allocating unit will be explained to program P2 shown in FIG. 16.

Program P2 is composed from seven functions (function main, function f1, function f2, function f3, function f4, function f5, and function f6). In program P2, functions f1, f2, f6 are called from function main, and three functions of function f3, function f4 and function f5 are called from function f2. Moreover, the code size of each function is assumed to be all 16 bytes.

The start address and the size of the instruction memory are assumed to be 64 bytes that start from 0x200000 as well as the program development supporting apparatus according to the second embodiment of the present invention.

(Call Graph of Program P2)

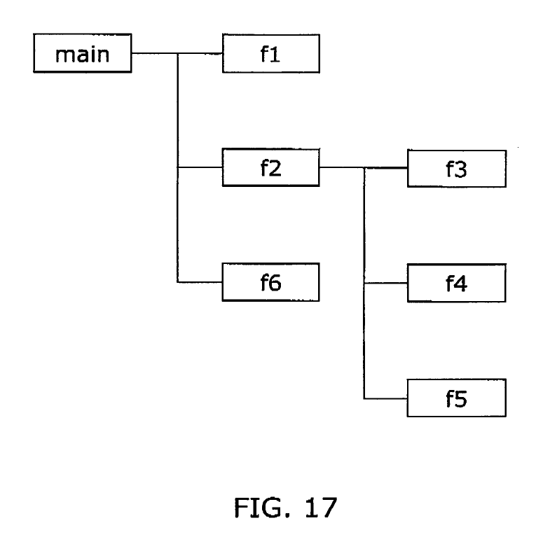

In the program development supporting apparatus according to the third embodiment of the present invention, the call graph of program P2 is expressed as shown schematically in FIG. 17.

Moreover, since initial state A_init based on this makes all functions another section, it is expressed as follows:
A_init=[{main}, {f1}, {f2}, {f3}, {f4}, {f5}, {f6}].

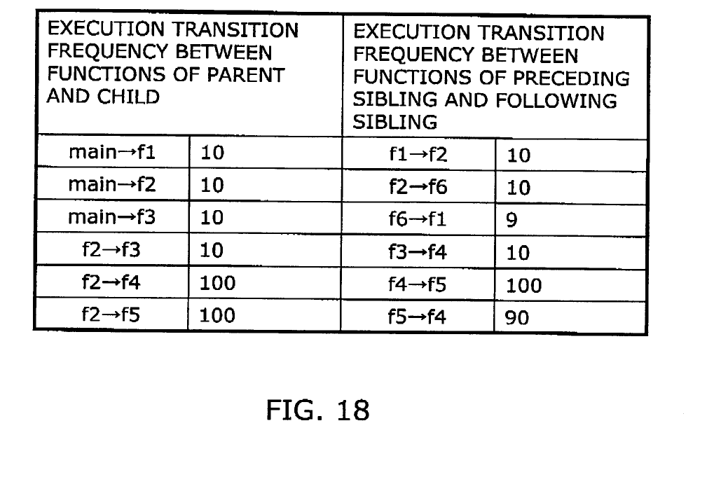

The result of obtaining the execution transition frequency between functions from the call relations between functions in FIG. 16 is shown in FIG. 18.

In the program development supporting apparatus according to the third embodiment of the present invention, the execution transition frequency between functions of program P2 is expressed as shown schematically in FIG. 18.

Consolidating of the section is tried from the part with largest transition frequencies within the range where the size upper limit of the instruction memory is not exceeded based on the execution transition frequency of FIG. 18.

The combinations of function f4 and f5 is the function pair with the largest execution transition frequency; 190 times in total according to 100 times of f4->f5 and 90 times of f5->f4. Here, when section S(f4) and S(f5) are consolidated, {main} is 16 bytes, {f2} is 16 bytes, and {f4, f5} is 32 bytes in the size of path P(main,f2,f4) of the maximum size including new section {f4, f5} and P(main,f2,f5). Therefore, consolidating is executed since it is suppressed to 64 bytes or less that are the size upper limits of the instruction memory.

Next to the combination with the largest executions transition frequencies are f2 and f4, and f2 and f5. However, when {f2} and {f4,f5} are consolidated, as for the size of path P(main,f2,f3), {main} is 16 bytes, {f2, f4, f5} is 48 bytes, {f3} is 16 bytes, and the total size exceeds 64 bytes. Therefore, consolidating is not executed. Furthermore, function pairs with ten execution transition frequencies will not consolidated, as the size of generated paths will exceed 64 bytes.

As for the combination of function f1 and f6 whose execution transition frequencies are nine times, {main} is 16 bytes and {f1, f6} is 32 bytes in the size of path P(main,f1) and P(main,f6) of the maximum size after the section consolidation, so sections S(f1) and S(f6) are consolidated.

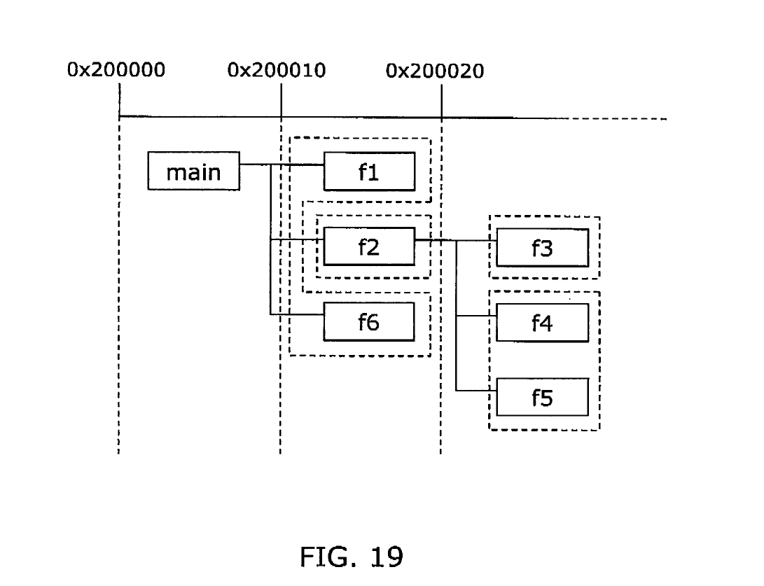

Consequently, the section consolidation of f1 and f6, and f4 and f5 is executed. Finality is shown as follows (Refer to FIG. 19):
A_init=[{main}, {f1,f6},{f2},{f3},{f4,f5}].
(Result of Allocating Function Section of Program P2)

In the program development supporting apparatus according to the third embodiment of the present invention, a result of allocating the function section of program P2 is shown schematically in FIG. 19.

In this example, although the application example of program P2 that the function execution history is decided to nothing but one has been explained, it is actually usual to obtain plural different function execution history according to the input data of the program. In that case, it is also possible to give the plural function execution history as input of the program development supporting apparatus according to the third embodiment of the present invention. When the plural function execution history assumes to be input, the execution transition frequency of the combination of the same functions may be totaled simply, and the user may specify a suitable multiplier respectively according to the severity of an individual function execution history and then the sum of products may be operated.

### Modified Example of the Third Embodiment

It is assumed that all functions are allocated in the distinct section in initial state A_init in the second embodiment and the third embodiment of the present invention. However, it is also possible to specify for the designer of the program to locate the combination and the set of specific functions to the same section explicitly in consideration of the program behavior flow. In that case, after the section of the function group that the designer initially specified is consolidated in A_init, the processing of the section allocating unit is executed.

According to the program development supporting apparatus according to the third embodiment of the present invention, in the development of the program that operates on the processor of the limited instruction memory capacity, by using the program itself and execution result of the program as an input, the allocation of program's instruction codes to memory area specified by instruction memory size constraint can be automatically obtained, where the program uses the instruction memory efficiently with decreased overhead of overlay.

### Other Embodiments

Although the embodiments of the present invention have been described in detail, the present invention may be embodied in other specific forms without departing from the spirit or essential characteristics thereof.

The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. An apparatus for supporting program development, the apparatus comprising:
a function calling information input unit configured to extract call relation of a function from a source file;
a link configuration file input unit configured to extract locating information on an absolute section from a configuration file used when linking;
a section editing unit configured to place the function in one of a relocatable section and the absolute section;
a function locating configuration file output unit configured to output the locating information on the function as a function locating configuration file; and
a link configuration file output unit configured to output the locating information on the relocatable section and the absolute section.

2. The apparatus of claim 1, wherein the function locating configuration file output unit and the link configuration file output unit display a function call graph of a program, an information of a function selected from the function call graph, the locating information on the relocatable section and the locating information on the absolute section on same display screen at the same time.

3. The apparatus of claim 1, wherein a source file is specified by using a source file name extracted from the source level debugging information in the absolute object file after linking.

4. An apparatus for supporting program development, the apparatus comprising:
a function calling information input unit configured to extract call relation of a function from a source file;
a link configuration file input unit configured to extract locating information on an absolute section from a configuration file used when linking;
a section allocation unit configured to obtain allocation of program code to an instruction memory area;
a function locating configuration file output unit configured to output the locating information on the function as a function locating configuration file; and
a link configuration file output unit configured to output the locating information on the relocatable section and the absolute section.

5. The apparatus of claim 4, wherein the section allocation unit obtains the allocation of the program code to the instruction memory area based on a function call graph.

6. The apparatus of claim 5, wherein the section allocation unit has:
a function section initial locating unit configured to allocate all functions contained of a program to the distinct sections;
a section locating address determination unit configured to determine a location address of all sections based on the function call graph; and
a section consolidation unit configured to consolidate the sections based on the function call graph and an instruction memory constraint.

7. The apparatus of claim 6, wherein the section locating address determination unit locates a section of a root function that is not called from other functions to the start address of the instruction memory constraint, and locates a section of the individual child function that is called from the root function to the address of the immediate aftermath of the section of the root function respectively.

8. The apparatus of claim 6, wherein the section consolidation unit obtains a path from the root function to individual leaf function in the function call graph, obtains the total of the code size of the section of each function of each path, and consolidate two sections, if the total of the code size of the paths that contain the two sections does not exceed the constraint of the instruction memory.

9. The apparatus of claim 8, wherein two functions allocated the two sections are called from the same parent function on the call graph, and the call locations of the two functions in the parent function are next to each other.

10. The apparatus of claim 9, wherein the section consolidation unit consolidates the sections sequentially from the one that the total of code size is the largest for each path.

11. The apparatus of claim 10, wherein the section consolidation unit consolidates the sections sequentially from the leaf function of each path.

12. The apparatus of claim 8, wherein two functions allocated the two sections are a parent function and a child function called from the parent function.

13. The apparatus of claim 12, wherein the section consolidation unit consolidates the section sequentially from the one that the total of code size is the largest for each path.

14. The apparatus of claim 13, wherein the section consolidation unit consolidates the section sequentially from the leaf function of each path.

15. The apparatus of claim 5, wherein the section allocation unit obtains the allocation of the program code to the instruction memory area by inputting function execution history that is function calling sequence at the program execution.

16. The apparatus of claim 15, wherein the section allocation unit has:
a function section initial locating unit configured to allocate all functions contained of a program to the distinct sections;
a section locating address determination unit configured to determine a location address of all sections based on the function call graph; and
a section consolidation unit configured to consolidate the sections based on the function call graph, the execution transition frequency between functions and an instruction memory constraint.

17. The apparatus of claim 16, wherein the section allocation unit tries to consolidate sections of two functions in order of the number of execution transition frequencies between those functions, if the total of the code size of the paths that contain the two sections does not exceed the constraint of the instruction memory.

18. A method for an operation of the apparatus for supporting program development, the method comprising:
extracting call relation of a function from a source file;
extracting locating information to a relocatable section of the function from a function locating information file;
extracting locating information on an absolute section from a configuration file used when linking;
placing the function in one of a relocatable section and the absolute section;
outputting the locating information on the function as a function locating configuration file; and
outputting the locating information on the relocatable section and the absolute section.

19. The method of claim 18, wherein in the outputting the locating information on the function as a function locating configuration file and the outputting the locating information on the relocatable section and the absolute section, a function call graph of a program, an information of a function selected from the function call graph, the locating information on the relocatable section and the locating information on the absolute section are displayed on same display screen at the same time.

20. The method of claim 18, further comprising:
specifying a source file by using a source file name extracted from the source level debugging information in the absolute object file after linking.
